(19) United States
(12) Patent Application Publication
(10) Pub. No.: US 2025/0184891 A1
(43) Pub. Date: Jun. 5, 2025

(54) METHOD, USER EQUIPMENT AND BASE STATION

(71) Applicant: NEC Corporation, Minato-ku, Tokyo (JP)

(72) Inventors: Yuhua Chen, London (GB); Robert Amott, London (GB)

(73) Assignee: NEC Corporation, Minato-ku, Tokyo (JP)

(21) Appl. No.: 18/842,088

(22) PCT Filed: Apr. 4, 2023
(86) PCT No.: PCT/JP2023/014013

§ 371 Date: Aug. 28, 2024

(30) Foreign Application Priority Data
Apr. 8, 2022 (GB) 2205219.5

(51) Int. Cl. H04W 52/02; H04W 72/231; H04W 76/28

(52) U.S. Cl. CPC H04W 52/0216; H04W 52/0274; H04W 76/28; H04W 72/231

(57) ABSTRACT

A method performed by a user equipment (UE) includes: receiving, from an access network node, information for indicating a start offset of an on-duration period of a discontinuous reception (DRX) cycle relative to a specific system frame number (SFN), and non-integer number of milliseconds of the on-duration period of the DRX cycle, the non-integer number of milliseconds corresponding to a video frame rate; and configuring the on-duration period of the DRX cycle based on the information.

### TECHNICAL FIELD

The present disclosure relates to a wireless communication system and devices thereof operating according to the 3rd Generation Partnership Project (3GPP) standards or equivalents or derivatives thereof.

### BACKGROUND ART

The disclosure has particular but not exclusive relevance to improvements relating to power saving techniques such as discontinuous reception in the so-called ‘5G’ or ‘New Radio’ systems (also referred to as ‘Next Generation’ systems) and similar systems.

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. Communication devices might be, for example, mobile communication devices such as mobile telephones, smartphones, smart watches, personal digital assistants, laptop/tablet computers, web browsers, e-book readers, and/or the like. Such mobile (or even generally stationary) devices are typically operated by a user (and hence they are often collectively referred to as user equipment, ‘UE’) although it is also possible to connect Internet of Things (IoT) devices and similar Machine Type Communications (MTC) devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as MTC/IoT communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

End-user communication devices are commonly referred to as User Equipment (UE) which may be operated by a human or comprise automated (MTC/IoT) devices. Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP Technical Specification (TS) 38.300 V16.7.0 and 3GPP TS 37.340 V16.7.0 define the following nodes, amongst others:
gNB: node providing NR user plane and control plane protocol terminations towards the UE, and connected via the NG interface to the 5G core network (5GC).
ng-eNB: node providing Evolved Universal Terrestrial Radio Access (E-UTRA) user plane and control plane protocol terminations towards the UE, and connected via the NG interface to the 5GC.
En-gNB: node providing NR user plane and control plane protocol terminations towards the UE, and acting as Secondary Node in E-UTRA-NR Dual Connectivity (EN-DC).
NG-RAN node: either a gNB or an ng-eNB.

The term base station or RAN node is used herein to refer to any such node.

The next-generation mobile networks support diversified service requirements, which have been classified into three categories by the International Telecommunication Union (ITU): Enhanced Mobile Broadband (eMBB); Ultra-Reliable and Low-Latency Communications (URLLC); and Massive Machine Type Communications (mMTC). eMBB aims to provide enhanced support of conventional mobile broadband, with focus on services requiring large and guaranteed bandwidth such as High Definition (HD) video, Virtual Reality (VR), and Augmented Reality (AR). URLLC is a requirement for critical applications such as automated driving and factory automation, which require guaranteed access within a very short time. MMTC needs to support massive number of connected devices such as smart metering and environment monitoring but can usually tolerate certain access delay. It will be appreciated that some of these applications may have relatively lenient Quality of Service/Quality of Experience (QoS/QoE) requirements, while some applications may have relatively stringent QoS/QoE requirements (e.g. high bandwidth and/or low latency).

Communication between the UEs and the base station is controlled using the so-called Radio Resource Control (RRC) protocol. The base station may optimise power consumption for the UE(s) by configuring a so-called Discontinuous Reception (DRX) and/or Discontinuous Transmission (DTX) operation. Both DRX and DTX are based on reducing the UE's transceiver duty cycle while in active operation. In DRX mode, the base station sets a cycle during which the UE is operational for a certain period of time (referred to as ‘active time’ or ‘on duration’) and the base station transmits all scheduling and paging information (for this UE) during this period only. The UE can thus turn off its transceiver for the rest of the DRX cycle (which may also be referred to as ‘inactive time’ or ‘off duration’). In DTX mode, the UE does not turn off its transceiver completely, but keeps monitoring the Physical Downlink Control Channel (PDCCH) to be able to receive data from the base station without undue delay. The longer the ‘off’ duration relative to the duty cycle, the more power saving can be achieved. However, when operating in DRX and/or DTX mode, the UE's data throughput is reduced in proportion to the achieved power savings since the UE can transmit/receive data during the active time only.

The term extended reality (XR) refers to all real-and-virtual combined environments and associated human-machine interactions generated by computer technology and wearables. It includes representative forms such as augmented reality (AR), mixed reality (MR), and virtual reality (VR) and the areas interpolated among them. 3GPP Technical Report (TR) 26.928 V16.1.0 discusses eXtended Reality (XR) in the context of 5G radio and network services. This document introduces baseline technologies for XR type of services and applications, outlining the quality of experience (QoE)/quality of service (QoS) issues of XR-based services, the delivery of XR in 5G systems, and an architectural model of 5G media streaming defined in 3GPP TS 26.501 V16.9.0. In addition to the conventional service category, interactive, streaming, download, and split compute/rendering are identified as new delivery categories for XR. 3GPP TR 38.838 V17.0.0 is a study on XR service and in particular the traffic models and characteristics aspects of XR in Release 17.

### SUMMARY OF INVENTION

### Technical Problem

The inventors have realised that some of the existing techniques may not work properly for XR services due to the special characteristics of XR related data and requirements. For example, when DRX is used, the arrival rate or timing of XR data may not always match the on period of the DRX configuration used by the UE leading to potential packet delays or packet losses of the XR service and poor user experience. An example of such a timing mismatch is shown in FIG. 5. Using the current techniques, this issue may be addressed by configuring a longer on period for the DRX cycle in which case packet arrival times will more likely coincide with the on period. However, as discussed above, a DRX cycle with a longer on period (i.e. shorter off period) would result in less power saving for the UE. Alternatively, DRX reconfiguration may be used to adapt the UE's currently used on/off periods to match the timing of XR data packet arrival. However, such reconfiguration involves RRC signalling and it takes relatively long, especially in the CU-DU split/distributed base station architecture.

One of the issues may be referred to as ‘non-integer periodicity’ of XR data packets (i.e. non-integer number of subframes). Specifically, in case of XR, the packet arrival rate is determined by the frame generation rate (e.g. 60 fps). Accordingly, the average packet arrival periodicity is given by the inverse of the frame rate (e.g. 1/60 fps=16.6667 ms), without considering Jitter (i.e. assuming fixed video encoding time, fixed network transfer delay). Thus, the arrival time at the base station for a packet with index k (k=1, 2, 3, . . . ) is given as k/F*1000 [ms] where F is the given frame generation rate (per second). The difference between the non-integer arrival rate (in this example 16.6667 ms) and the nearest periodicity given in units of subframes (e.g. 17 ms) causes the buffer time of subsequent packets to get longer and longer (accumulated). In other words, an additional 0.3333 ms delay may be added (and accumulated) at each new data packet corresponding to a new frame.

In addition, jitter may also cause misalignment between data arrival and the on period of the DRX cycle. The effect of jitter is that the exact frame arrival timing would be a bit earlier or later than expected due to a random delay, which is caused by the operation of frame encoders in edge servers, network transfer time in the core network, etc. An example of jitter is shown in FIG. 6. Jitter may also be addressed by configuring a longer on period for the UE's DRX cycle, for example, by adding a certain time margin before and after the expected arriving time when configuring the on-duration. However, this would make the on period unnecessarily long and would limit the amount of power saving that can be achieved.

XR data is also characterised by multiple data flows (e.g. separate flow for left eye and right eye, separate audio data). In the so-called dual eye buffer model of data, the left and right eye frames arrive separately with a time offset between them (which may also be affected by a different amount of jitter). In certain two stream models, XR video and audio streams may have different periodicities (e.g. 16.6667 and 10 ms, respectively), different packet delay budgets (e.g. 10 ms vs 30 ms), and different packet sizes. Thus, it may be difficult to configure a DRX cycle that is suitable for multiple data flows.

### Solution to Problem

Accordingly, the present disclosure seeks to provide methods and associated apparatus that address or at least alleviate (at least some of) the above-described issues.

In one aspect, the disclosure provides a method performed by a user equipment (UE), the method comprising: receiving, via a first control signalling, first information for configuring the UE with a discontinuous reception of data based on a cycle, wherein the cycle includes an active portion during which data may be transmitted for the UE and an inactive portion during which data is not transmitted for the UE; receiving, via a second control signalling, second information for identifying, for a current iteration of the cycle, a starting point of the active portion; and receiving data in the active portion of the current iteration of the cycle, based on the starting point identified by the second information.

In one aspect, the disclosure provides a method performed by a user equipment (UE), the method comprising: receiving first information for configuring the UE for discontinuous reception of data based on a cycle, wherein the cycle includes a plurality of active portions during which data may be transmitted for the UE and at least one inactive portion during which data is not transmitted for the UE; receiving second information identifying, for at least one active portion, a respective offset for a starting point of that active portion in a current iteration of the cycle; and receiving data in the plurality of active portions in the current iteration of the cycle, based on the second information.

In one aspect, the disclosure provides a method performed by a user equipment (UE), the method comprising: receiving first information for configuring the UE for discontinuous reception of data based on a plurality of cycles, wherein each cycle includes an active portion during which data may be transmitted for the UE and an inactive portion during which data is not transmitted for the UE; receiving second information identifying at least one cycle to be used by the UE in at least one cell; and receiving data in the active portion in a current iteration of the at least one cycle.

In one aspect, the disclosure provides a method performed by a user equipment (UE), the method comprising: receiving information for configuring the UE for a discontinuous reception of data based on a cycle defined as a function of an arrival rate of data packets for a service, wherein the cycle includes an active portion during which data may be transmitted for the UE and an inactive portion during which data is not transmitted for the UE, wherein the information includes information identifying an offset for determining a starting time of an initial active portion in relation to a specific system frame and information identifying a periodicity between the starting time of the initial active portion and a starting time of any subsequent active portion.

In one aspect, the disclosure provides a method performed by a user equipment (UE), the method comprising: receiving information for configuring the UE with a discontinuous reception of data based on a cycle, wherein the cycle includes an active portion during which data may be transmitted for the UE and an inactive portion during which data is not transmitted for the UE, wherein the information includes information identifying, on a slot or a symbol level, a length of the cycle and a length of the active portion.

In one aspect, the disclosure provides a method performed by base station, the method comprising: transmitting, to a user equipment (UE), via a first control signalling, first information for configuring the UE with a discontinuous reception of data based on a cycle, wherein the cycle includes an active portion during which data may be transmitted for the UE and an inactive portion during which data is not transmitted for the UE; transmitting, to the UE, via a second control signalling, second information for identifying, for a current iteration of the cycle, a starting point of the active portion; and transmitting, to the UE, data in the active portion of the current iteration of the cycle, based on the starting point identified by the second information.

In one aspect, the disclosure provides a method performed by base station, the method comprising: transmitting, to a user equipment (UE), first information for configuring the UE for discontinuous reception of data based on a cycle, wherein the cycle includes a plurality of active portions during which data may be transmitted for the UE and at least one inactive portion during which data is not transmitted for the UE; transmitting, to the UE, second information identifying, for at least one active portion, a respective offset for a starting point of that active portion in a current iteration of the cycle; and transmitting, to the UE, data in the plurality of active portions in the current iteration of the cycle, based on the second information.

In one aspect, the disclosure provides a method performed by base station, the method comprising: transmitting, to a user equipment (UE), first information for configuring the UE for discontinuous reception of data based on a plurality of cycles, wherein each cycle includes an active portion during which data may be transmitted for the UE and an inactive portion during which data is not transmitted for the UE; transmitting, to the UE, second information identifying at least one cycle to be used by the UE in at least one cell; and transmitting, to the UE, data in the active portion in a current iteration of the at least one cycle.

In one aspect, the disclosure provides a method performed by base station, the method comprising: transmitting, to a user equipment (UE), information for configuring the UE for a discontinuous reception of data based on a cycle defined as a function of an arrival rate of data packets for a service, wherein the cycle includes an active portion during which data may be transmitted for the UE and an inactive portion during which data is not transmitted for the UE, wherein the information includes information identifying an offset for determining a starting time of an initial active portion in relation to a specific system frame and information identifying a periodicity between the starting time of the initial active portion and a starting time of any subsequent active portion.

In one aspect, the disclosure provides a method performed by base station, the method comprising: transmitting, to a user equipment (UE), information for configuring the UE with a discontinuous reception of data based on a cycle, wherein the cycle includes an active portion during which data may be transmitted for the UE and an inactive portion during which data is not transmitted for the UE, wherein the information includes information identifying, on a slot or a symbol level, a length of the cycle and a length of the active portion.

In one aspect, the disclosure provides a user equipment (UE) comprising: means (for example a memory, a controller, and a transceiver) for receiving, via a first control signalling, first information for configuring the UE with a discontinuous reception of data based on a cycle, wherein the cycle includes an active portion during which data may be transmitted for the UE and an inactive portion during which data is not transmitted for the UE; means for receiving, via a second control signalling, second information for identifying, for a current iteration of the cycle, a starting point of the active portion; and means for receiving data in the active portion of the current iteration of the cycle, based on the starting point identified by the second information.

In one aspect, the disclosure provides a user equipment (UE) comprising: means (for example a memory, a controller, and a transceiver) for receiving first information for configuring the UE for discontinuous reception of data based on a cycle, wherein the cycle includes a plurality of active portions during which data may be transmitted for the UE and at least one inactive portion during which data is not transmitted for the UE; means for receiving second information identifying, for at least one active portion, a respective offset for a starting point of that active portion in a current iteration of the cycle; and means for receiving data in the plurality of active portions in the current iteration of the cycle, based on the second information.

In one aspect, the disclosure provides a user equipment (UE) comprising: means (for example a memory, a controller, and a transceiver) for receiving first information for configuring the UE for discontinuous reception of data based on a plurality of cycles, wherein each cycle includes an active portion during which data may be transmitted for the UE and an inactive portion during which data is not transmitted for the UE; means for receiving second information identifying at least one cycle to be used by the UE in at least one cell; and means for receiving data in the active portion in a current iteration of the at least one cycle.

In one aspect, the disclosure provides a user equipment (UE) comprising: means (for example a memory, a controller, and a transceiver) for receiving information for configuring the UE for a discontinuous reception of data based on a cycle defined as a function of an arrival rate of data packets for a service, wherein the cycle includes an active portion during which data may be transmitted for the UE and an inactive portion during which data is not transmitted for the UE, wherein the information includes information identifying an offset for determining a starting time of an initial active portion in relation to a specific system frame and information identifying a periodicity between the starting time of the initial active portion and a starting time of any subsequent active portion.

In one aspect, the disclosure provides a user equipment (UE) comprising: means (for example a memory, a controller, and a transceiver) for receiving information for configuring the UE with a discontinuous reception of data based on a cycle, wherein the cycle includes an active portion during which data may be transmitted for the UE and an inactive portion during which data is not transmitted for the UE, wherein the information includes information identifying, on a slot or a symbol level, a length of the cycle and a length of the active portion.

In one aspect, the disclosure provides a base station comprising: means (for example a memory, a controller, and a transceiver) for transmitting, to a user equipment (UE), via a first control signalling, first information for configuring the UE with a discontinuous reception of data based on a cycle, wherein the cycle includes an active portion during which data may be transmitted for the UE and an inactive portion during which data is not transmitted for the UE; means for transmitting, to the UE, via a second control signalling, second information for identifying, for a current iteration of the cycle, a starting point of the active portion; and means for transmitting, to the UE, data in the active portion of the current iteration of the cycle, based on the starting point identified by the second information.

In one aspect, the disclosure provides a base station comprising: means (for example a memory, a controller, and a transceiver) for transmitting, to a user equipment (UE), first information for configuring the UE for discontinuous reception of data based on a cycle, wherein the cycle includes a plurality of active portions during which data may be transmitted for the UE and at least one inactive portion during which data is not transmitted for the UE; means for transmitting, to the UE, second information identifying, for at least one active portion, a respective offset for a starting point of that active portion in a current iteration of the cycle; and means for transmitting, to the UE, data in the plurality of active portions in the current iteration of the cycle, based on the second information.

In one aspect, the disclosure provides a base station comprising: means (for example a memory, a controller, and a transceiver) for transmitting, to a user equipment (UE), first information for configuring the UE for discontinuous reception of data based on a plurality of cycles, wherein each cycle includes an active portion during which data may be transmitted for the UE and an inactive portion during which data is not transmitted for the UE; means for transmitting, to the UE, second information identifying at least one cycle to be used by the UE in at least one cell; and means for transmitting, to the UE, data in the active portion in a current iteration of the at least one cycle.

In one aspect, the disclosure provides a base station comprising: means (for example a memory, a controller, and a transceiver) for transmitting, to a user equipment (UE), information for configuring the UE for a discontinuous reception of data based on a cycle defined as a function of an arrival rate of data packets for a service, wherein the cycle includes an active portion during which data may be transmitted for the UE and an inactive portion during which data is not transmitted for the UE, wherein the information includes information identifying an offset for determining a starting time of an initial active portion in relation to a specific system frame and information identifying a periodicity between the starting time of the initial active portion and a starting time of any subsequent active portion.

In one aspect, the disclosure provides a base station comprising: means (for example a memory, a controller, and a transceiver) for transmitting, to a user equipment (UE), information for configuring the UE with a discontinuous reception of data based on a cycle, wherein the cycle includes an active portion during which data may be transmitted for the UE and an inactive portion during which data is not transmitted for the UE, wherein the information includes information identifying, on a slot or a symbol level, a length of the cycle and a length of the active portion.

Aspects of the disclosure extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Although for efficiency of understanding for those of skill in the art, the disclosure will be described in detail in the context of a 3GPP system (5G networks), the principles of the disclosure can be applied to other systems as well.

The present disclosure is defined by the claims appended hereto. Aspects of the disclosure are as set out in the independent claims. Some optional features are set out in the dependent claims.

However, each feature disclosed in this specification (which term includes the claims) and/or shown in the drawings may be incorporated in the disclosure independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Embodiments of the disclosure will now be described, by way of example, with reference to the accompanying drawings in which:

FIG. 1 illustrates schematically a mobile (cellular or wireless) telecommunication system to which embodiments of the disclosure may be applied;

FIG. 2 is a schematic block diagram of a mobile device forming part of the system shown in FIG. 1;

FIG. 3 is a schematic block diagram of an access network node (e.g. base station) forming part of the system shown in FIG. 1;

FIG. 4 is a schematic block diagram of a core network node forming part of the system shown in FIG. 1;

FIG. 5 is schematic diagrams illustrating an exemplary embodiment of the present disclosure;

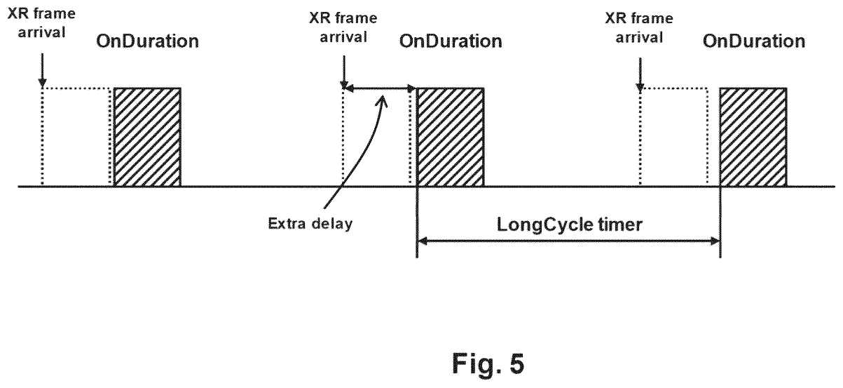

FIG. 6 is schematic diagram illustrating an exemplary embodiment of the present disclosure;

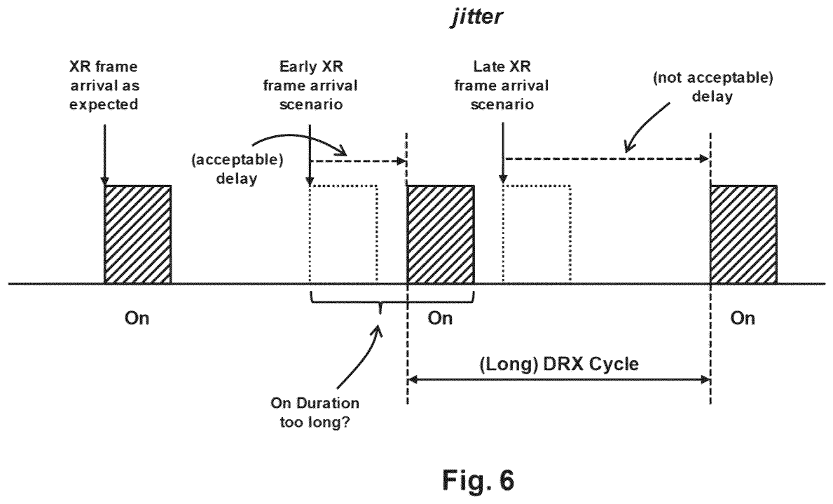

FIG. 7 is schematic diagram illustrating an exemplary embodiment of the present disclosure;

FIG. 8 is schematic diagram illustrating an exemplary embodiment of the present disclosure;

FIG. 9 is schematic diagram illustrating an exemplary embodiment of the present disclosure;

FIG. 10 is schematic diagram illustrating an exemplary embodiment of the present disclosure;

FIG. 11 is schematic diagram illustrating an exemplary embodiment of the present disclosure; and

FIG. 12 is schematic diagram illustrating an exemplary embodiment of the present disclosure.

### DESCRIPTION OF EMBODIMENTS

### Overview

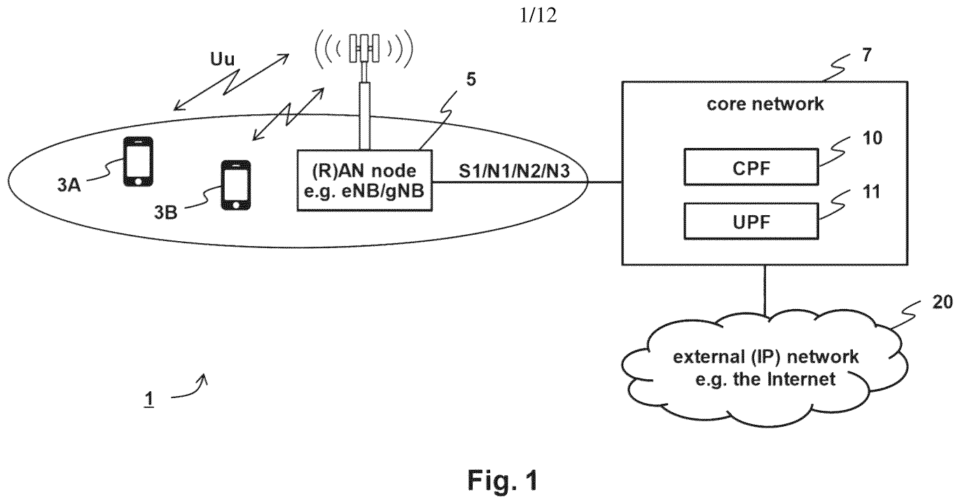

FIG. 1 illustrates schematically a mobile (cellular or wireless) telecommunication system 1 to which embodiments of the disclosure may be applied.

In this system 1, users of mobile devices 3 (UEs) can communicate with each other and other users via base stations 5 (and other access network nodes) and a core network 7 using an appropriate 3GPP radio access technology (RAT), for example, an Evolved Universal Terrestrial Radio Access (E-UTRA) and/or a 5G RAT. It will be appreciated that a number of base stations 5 form a (radio) access network or (R)AN. As those skilled in the art will appreciate, whilst two mobile devices 3A and 3B and one base station 5 are shown in FIG. 1 for illustration purposes, the system, when implemented, will typically include other base stations/(R)AN nodes and mobile devices (UEs).

Each base station 5 controls one or more associated cell (either directly or via other nodes such as home base stations, relays, remote radio heads, distributed units, and/or the like). A base station 5 that supports Next Generation/5G protocols may be referred to as a ‘gNBs’. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘NR’ air interface, the ‘Uu’ interface, and/or the like). Neighbouring base stations 5 are connected to each other via an appropriate base station to base station interface (such as the so-called ‘Xn’ interface, the ‘X2’ interface, and/or the like). The base stations 5 are also connected to the core network nodes via an appropriate interface (such as the so-called ‘NG-U’ interface (for user-plane), the so-called ‘NG-C’ interface (for control-plane), and/or the like).

The core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities, such as one or more control plane functions (CPFs) 10 and one or more user plane functions (UPFs) 11. For example, the so-called Access and Mobility Management Function (AMF) in 5G, or the Mobility Management Entity (MME) in 4G, is responsible for handling connection and mobility management tasks for the mobile devices 3. The so-called Session Management Function (SMF) is responsible for handling communication sessions for the mobile devices 3 such as session establishment, modification and release. The core network 7 may typically also include an Authentication Server Function (AUSF), a Unified Data Management (UDM) entity, a Policy Control Function (PCF), an Application Function (AF), amongst others. It will be appreciated that the nodes or functions may have different names in different systems. The core network 7 is coupled (via the UPF 11) to a data network 20, such as the Internet or a similar Internet Protocol (IP) based network. The core network 7 may also be coupled to an Operations and Maintenance (OAM) function (not shown).

It will be appreciated that each mobile device 3 may support one or more services which may fall into one of the categories defined above (URLLC/eMBB/mMTC). Each service will typically have associated requirements (e.g. latency/data rate/packet loss requirements, etc.), which may be different for different services. Each mobile device may be configured with appropriate power saving operation such as DRX, DTX, and/or the like. The power saving operation may depend on the category of the service(s) used, UE capabilities, and other factors (such as QoE/QoS, throughput, serving cell(s), network load, and/or the like).

In this system, the DRX configuration used by a UE 3 may be adapted dynamically to suit a wide range of services, such as XR data.

Beneficially, this is achieved by configuring the basic parameters for a discontinuous reception cycle using first control signalling (e.g. RRC signalling) and by identifying, using second control signalling a starting subframe of the active portion of the discontinuous reception cycle. The discontinuous reception cycle (or DRX cycle) includes an active portion during which data may be transmitted for the UE 3 and an inactive portion during which data is not transmitted for the UE. The second control signalling may include at least one of: medium access control (MAC) layer signalling; physical (PHY) layer signalling; and downlink control information (DCI) signalling.

The second control signalling (e.g. MAC/PHY/DCI signalling) may identify the starting subframe of the active portion by including at least one of: information identifying a start offset relative to a starting subframe of the current iteration of the discontinuous reception cycle; information identifying an adjustment value to be applied to a current start offset; information identifying an index of a specific starting subframe for the current iteration of the discontinuous reception cycle; information identifying a discontinuous reception configuration to be applied in the current iteration of the discontinuous reception cycle; information identifying a length of the active portion applicable in the current iteration of the discontinuous reception cycle; and information indicating whether the active portion is enabled in the current iteration of the discontinuous reception cycle.

The first control signalling may be used to configure a plurality of candidate active portions for the discontinuous reception cycle, each candidate active portion having an associated starting position (starting subframe). In this case, the second control signalling can be used to identify, for the current iteration of the cycle, the starting position of each candidate active portion by additionally indicating which candidate active portion is about.

Beneficially, it is possible to dynamically adapt the start of the next on duration/active time (and start the associated on duration timer) based on the start offset/start offset adjustment, which may be signalled separately from the DRX configuration. From the network's point of view, the base station 5 can avoid having to buffer data that arrives too early (or too late) compared to the UE's regular DRX on period by transmitting an appropriate MAC CE or DCI indicating the currently applicable start offset. Moreover, if the UE 3 has more than one DRX configurations (e.g. multiple DRX cycles and/or DRX groups), the MAC CE (or DCI) may be used to identify which DRX configuration needs to be adjusted by the start offset/start offset adjustment value.

In order to provide a more granular (e.g. slot or symbol level) cycle and active time/on duration, a discontinuous reception cycle may be defined based on the following two parameters:
tₛₜₐᵣₜ: offset of the first on duration measured from the start of (a specific) SFN #0; and
t_{period}: period between the start points of two consecutive on durations.

In principle the parameters tₛₜₐᵣₜ and t_{period} may have any arbitrary value but in practice it would be more convenient to define them as multiples of a basic unit, e.g. 1/1024 ms.

Alternatively, slot level granularity for the cycle and active time may be realised using an appropriate formula which takes into account a parameter that specifies the applicable slot level granularity. For example, this parameter may define a fraction of the DRX cycle at slot level granularity. Beneficially, for each iteration of the cycle, the UE 3 can determine a specific system frame number (SFN), subframe number, and slot number for starting the on duration timer, using the formula.

Furthermore, symbol level granularity for the cycle and active time may be realised using an appropriate formula which takes into account an additional parameter that specifies the applicable further symbol level DRX length. For example, this symbol level parameter may define additional DRX cycle portion at symbol granularity in addition to a DRX cycle portion configured in number of subframes and in number of slots. Beneficially, for each iteration of the cycle, the UE 3 can determine a specific system frame number (SFN), subframe number, slot number and symbol number for starting the on duration timer, using the formula.

### User Equipment (UE)

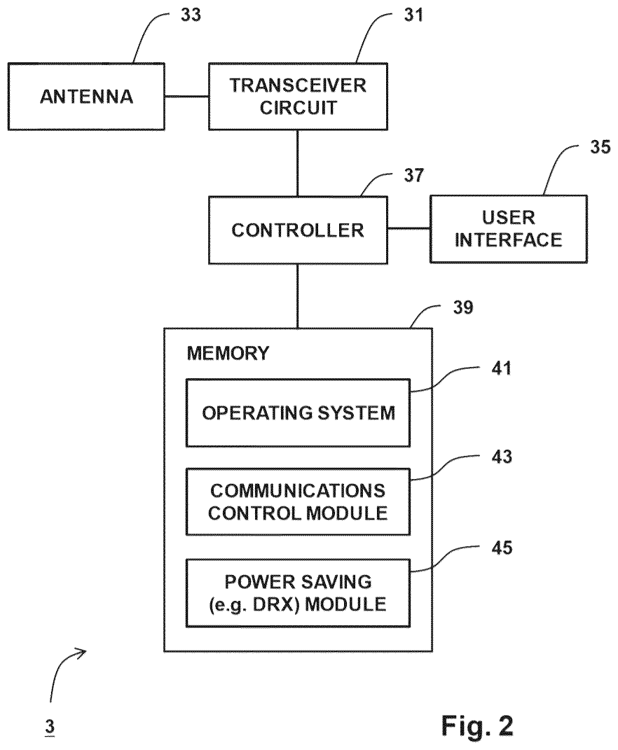

FIG. 2 is a block diagram illustrating the main components of the mobile device (UE) 3 shown in FIG. 1. As shown, the UE 3 includes a transceiver circuit 31 which is operable to transmit signals to and to receive signals from the connected node(s) via one or more antenna 33. Although not necessarily shown in FIG. 2, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43, and a power saving module 45 (such as a DRX module).

The communications control module 43 is responsible for handling (generating/sending/receiving) signalling messages and uplink/downlink data packets between the UE 3 and other nodes, including (R)AN nodes 5 and core network nodes. The signalling may comprise control signalling (e.g. via RRC/MAC/PHY/DCI) related to the power saving/DRX operation. It will be appreciated that the communications control module 43 may include a number of sub-modules (‘layers’ or ‘entities’) to support specific functionalities. For example, the communications control module 43 may include a PHY sub-module, a MAC sub-module, an RLC sub-module, a PDCP sub-module, an SDAP sub-module, an IP sub-module, an RRC sub-module, etc.

The power saving/DRX module 45 is responsible for obtaining appropriate configuration (e.g. via the communications control module 43) for a power saving operation. Power saving is typically achieved by turning off certain components (e.g. the transceiver circuit 31) for certain periods. In the case of a discontinuous reception operation (which term is also used herein to include discontinuous transmission as well) the control signalling may include information for configuring the UE 3 with a discontinuous reception/transmission in an active portion of a power saving/DRX cycle and information for identifying a starting subframe of the active portion.

### Access Network Node (Base Station)

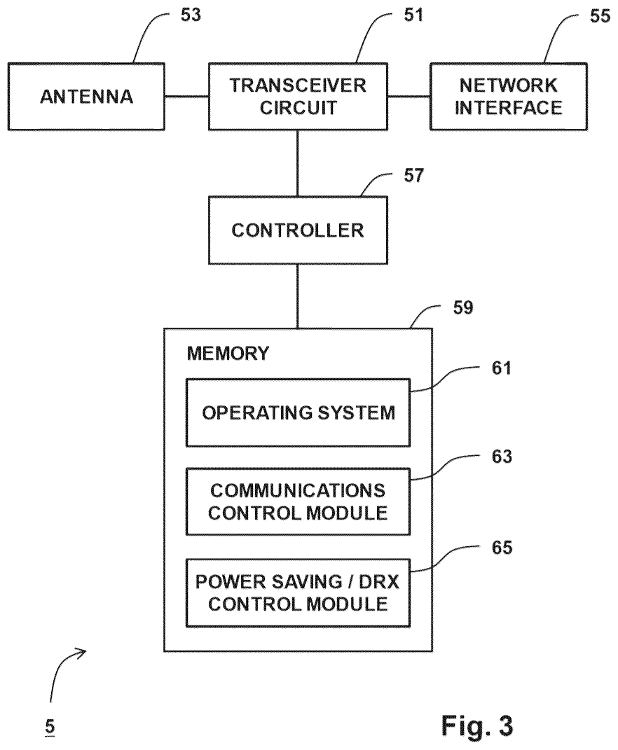

FIG. 3 is a block diagram illustrating the main components of the base station 5 (or a similar access network node) shown in FIG. 1. As shown, the base station 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. The network interface 55 typically includes an appropriate base station-base station interface (such as X2/Xn) and an appropriate base station-core network interface (such as S1/N1/N2/N3). A controller 57 controls the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61, a communications control module 63, and a power saving/DRX control module 65.

The communications control module 63 is responsible for handling (generating/sending/receiving) signalling between the base station 5 and other nodes, such as the UE 3 and the core network nodes. The signalling may comprise control signalling (e.g. via RRC/MAC/PHY/DCI) related to the power saving/DRX operation. It will be appreciated that the communications control module 63 may include a number of sub-modules (‘layers’ or ‘entities’) to support specific functionalities. For example, the communications control module 63 may include a PHY sub-module, a MAC sub-module, an RLC sub-module, a PDCP sub-module, an SDAP sub-module, an IP sub-module, an RRC sub-module, etc.

The power saving/DRX control module 65 is responsible for providing appropriate configuration for the UE 3 (e.g. via the communications control module 63) for a power saving operation applicable to that UE 3. In the case of a discontinuous reception operation the control signalling may include information for configuring the UE 3 with a discontinuous reception/transmission in an active portion of a power saving/DRX cycle and information for identifying a starting subframe of the active portion.

### Core Network Function

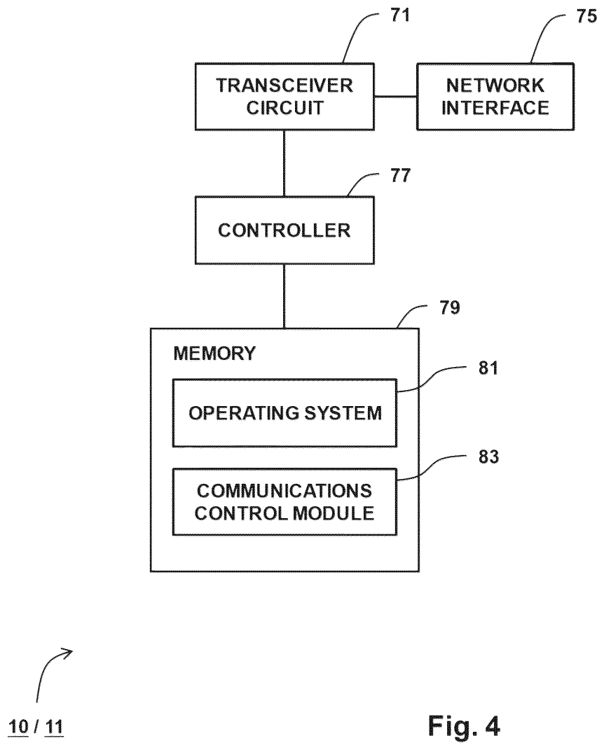

FIG. 4 is a block diagram illustrating the main components of a generic core network function, such as the CPF 10 or the UPF 11 shown in FIG. 1. As shown, the core network function includes a transceiver circuit 71 which is operable to transmit signals to and to receive signals from other nodes (including the UE 3, the base station 5, and other core network nodes) via a network interface 75. A controller 77 controls the operation of the core network function in accordance with software stored in a memory 79. The software may be pre-installed in the memory 79 and/or may be downloaded via the telecommunication network 1 or from a removable data storage device (RMD), for example. The software includes, among other things, an operating system 81, and a communications control module 83.

The communications control module 83 is responsible for handling (generating/sending/receiving) signaling between the core network function and other nodes, such as the UE 3, the base station 5, and other core network nodes.

### DETAILED DESCRIPTION

Connected mode DRX (C-DRX) is applicable to UEs 3 that do not need to monitor the PDCCH continuously even though they may have ongoing communication sessions relating to one or more service. With DRX, data transmissions for the UE 3 may be scheduled (may take place) during the active time of that UE 3.

In order to configure a UE 3 for DRX operation, the following parameters can be used:
DRX Long cycle: controls how frequently the UE 3 has to wake up (at least for the associated on duration) for potential scheduling (PDCCH monitoring);
StartOffset: defines where (in which subframe) the long or short DRX cycle starts or in which subframe the on duration starts;
On duration timer: determines the on duration window size for each DRX cycle (window size is given in units of consecutive subframes)—the on duration window is typically located at the beginning of the DRX cycle;
Inactivity timer: extended wake up time after receiving a scheduling PDCCH;
Short cycle (optional): a shorter DRX cycle following active time with data transmission;
Short cycle timer (optional): how long to use the shorter DRX cycle before switching back to the long DRX cycle (if no data);
drx-HARQ-RTT-TimerDL/UL and drx-RetransmissionTimerDL/UL (per hybrid automatic repeat request (HARQ) process): control when the UE 3 needs to wake up for potential retransmission scheduling for a given HARQ process; and
SlotOffset (optional): slot level delay before starting the on duration.

In addition, the DRX Command MAC control element (CE) and the Long DRX Command MAC CE may be used to stop the on duration timer and inactivity timer if running, in order to cut down the active time if there is no more packet in buffer for scheduling. The difference is that the DRX Common MAC CE will let the UE 3 start to use a short DRX cycle after receiving this MAC CE (if configured), while the Long DRX Command MAC CE will let the UE 3 start to use a long DRX cycle.

When DCP is configured, an appropriate DCI can be used indicate to the UE 3 whether it should start or should not start the on duration for the next long DRX cycle.

It is also possible to allocate cells into two DRX groups with shared DRX parameters other than the on duration timer and inactivity timer. Specifically, the serving cells of a MAC entity may be assigned by RRC to one of two DRX groups with separate on durations and separate inactive durations (configured using respective values for the drx-onDurationTimer and drx-InactivityTimer). The other DRX parameters are common for both groups.

In order to address timing mismatch and jitter in case of certain data streams, such as XR data streams, and to provide more flexibility for DRX operation without the need for excessive signalling (e.g. RRC reconfiguration), we discuss a number of solutions in the following. It will be appreciated that certain aspects of the various solutions may be applicable to (or combined with) all solutions even if it is not expressly mentioned.

### Solution 1

In this case, the base station 5 (using its power saving/DRX control module 65) configures the UE 3 with a DRX cycle. Specifically, the base station 5 generates and transmits an appropriately formatted RRC message (e.g. an ‘RRCReconfiguration’ or ‘RRCConnectionReconfiguration’ message) which includes a set of parameters for the DRX configuration, such as the ‘On duration timer’ and ‘Inactivity timer’ described above. It will be appreciated that other kind of control signalling may also be used, if appropriate.

If included in the RRC message, the value of the StartOffset parameter defines which subframe is the starting subframe of the DRX cycle (at least the first iteration thereof). However, the starting subframe configured via RRC may not coincide with the actual packet arrival time, especially in case of XR data due to timing mismatch and/or jitter. Thus, the base station 5 may be configured to omit the StartOffset parameter from the RRC message altogether. Alternatively, the UE 3 may be configured to disregard any StartOffset parameter included in the RRC message.

Instead, the StartOffset parameter may be indicated using a different control signalling, in a dynamic manner so that the starting point/on duration of the DRX cycle can be adapted to the actual data packet arrival, in each iteration of the DRX cycle.

For example, MAC/PHY control signalling may be used to configure the StartOffset. In the following description MAC signaling is used as an example, but the same or similar information may be carried in physical layer signalling (e.g. DCI).

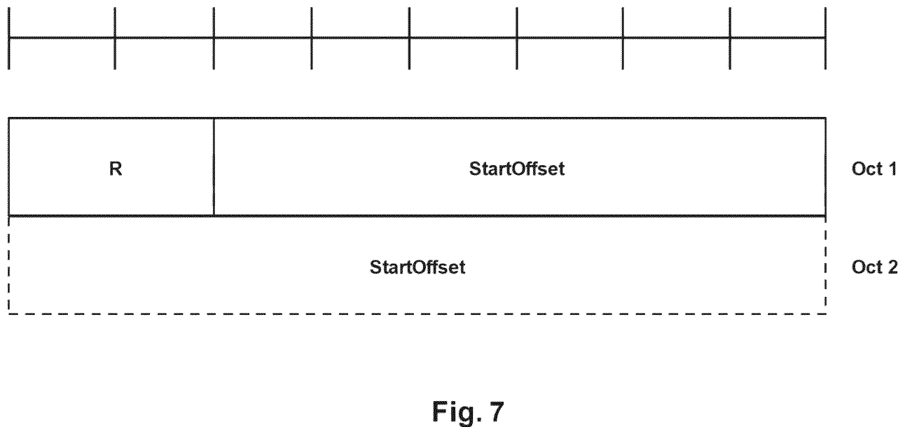

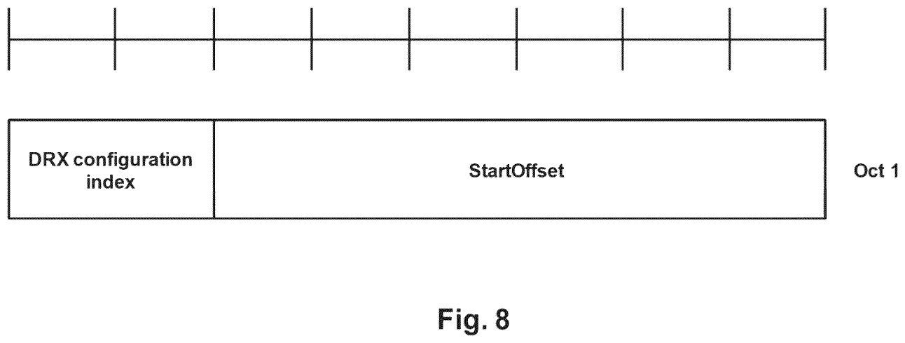

The MAC signalling may include an appropriately formatted MAC Control Element (MAC CE) to configure the start offset for the UE 3 (or to replace any start offset configured in RRC). For example, a new DRX StartOffset MAC CE or any other suitable MAC CE may be used. As shown in FIG. 7, the start offset may be signalled using one octet of information (e.g. six bits) although it will be appreciated that higher granularity may be achieved by using two (or more) octets. Six bits provide a 1 ms granularity for DRX cycles up to 64 ms, but only a 160 ms granularity for a 10240 ms DRX cycle. Accordingly, the number of octets may depend on the length of the DRX cycle. If multiple DRX configurations have been configured for the UE 3 (via RRC), one or more bits of the MAC CE may be used to indicate which DRX configuration the start offset should be applied to, as shown in FIG. 8. For example, if the UE 3 has a first DRX configuration (e.g. a long DRX cycle) and a second DRX configuration (e.g. a short DRX cycle or another long DRX cycle), index #0 may be associated with the first DRX configuration and index #1 may be associated with the second DRX configuration (or vice versa). When using a DCI, the start offset may be signalled using an appropriate field of the DCI.

Once the UE 3 has received the MAC CE (or DCI) that identifies the start offset, the UE 3 determines when to start the on duration timer (which controls the on duration) based on the start offset. Specifically, the UE 3 applies the received StartOffset parameter into an appropriate formula to calculate when to start the on duration timer. The formula depends on whether long or short DRX cycle is used.

In case of a long DRX cycle the following formula is used:

[(SFN×10)+subframe number]modulo(drx-LongCycle)=drx-StartOffset

where the value of ‘drx-StartOffset’ represents the start offset (in number of subframes) and where ‘drx-StartOffset’ is signalled separately (e.g. via MAC/PHY/DCI) from the RRC message that configured the applicable on duration timer and inactivity timer (and any other relevant parameters) for the DRX cycle.

In case of a short DRX cycle the following formula is used:

$$[ ( SFN \times 10 ) + subframe number ] modulo ( drx - ShortCycle ) = ( drx - StartOffset ) modulo ( drx - ShortCycle )$$

Beneficially, the UE 3 is able to dynamically adapt the start of the next on duration/active time (and start the associated on duration timer) based on the above formulas and the start offset. From the network's point of view, the base station 5 can avoid having to buffer data that arrives too early (or too late) compared to the UE's regular DRX on period by transmitting an appropriate MAC CE indicating the currently applicable start offset. Moreover, if the UE 3 has more than one DRX configurations (e.g. multiple DRX cycles and/or DRX groups), the MAC CE (or DCI) may be used to identify which DRX configuration needs to be adjusted by the start offset value.

It will be appreciated that the UE 3 may receive, via RRC, all necessary parameters for a configuring a DRX cycle. In this case, the UE 3 may be configured to either delay applying the DRX configuration until receiving the first StartOffset MAC CE (in other words DRX is initially deactivated i.e. the UE 3 is always active for PDCCH monitoring). Effectively, in this case, the MAC CE may be used to activate/enable the DRX configuration by identifying the applicable start offset (which may be the same offset as the offset configured via RRC). Alternatively, the UE 3 may be configured to start applying the DRX configuration received via RRC without delay, in which case the MAC CE may be used to update the DRX configuration by identifying a new start offset (applicable for, or from, the next iteration of the DRX cycle).

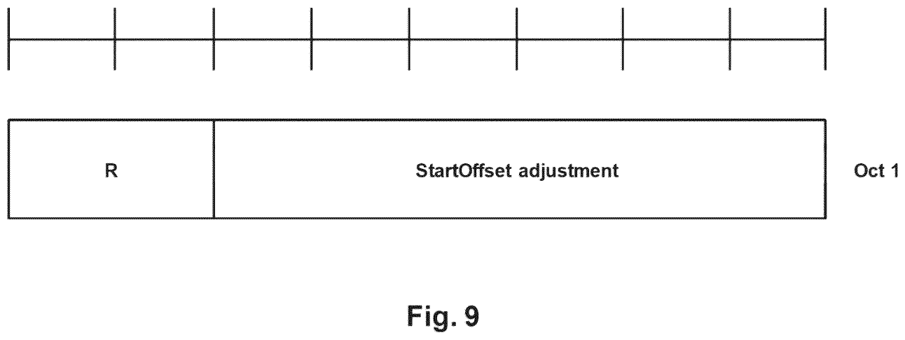

In a modification of this solution, the MAC CE (or PHY/DCI) may be used to indicate an adjustment to the currently used start offset. This approach is illustrated in FIG. 9. It will be appreciated that the adjustment may be either positive or negative (or zero).

Thus, when the UE 3 receives the MAC CE that identifies the start offset adjustment, the UE 3 determines when to start the on duration timer (which controls the on duration) based on the current start offset and the received adjustment value. Specifically, the UE 3 may use the following formula (for a long DRX cycle):

$$[ ( SFN \times 10 ) + subframe number ] modulo ( drx - LongCycle ) = drx - StartOffset + StartOffset adjustment$$

where the StartOffset adjustment value is signalled to the UE 3 via appropriate MAC/PHY/DCI signalling.

In case of a short DRX cycle the UE 3 may use the following formula:

$$[ ( SFN \times 10 ) + subframe number ] modulo ( drx - ShortCycle ) = ( drx - StartOffset + StartOffset adjustment ) modulo ( drx - ShortCycle )$$

It will be appreciated that the UE 3 may be configured to apply the adjustment value only for the next iteration of the DRX cycle (i.e. a single DRX cycle) and then revert to the previous start value (unless a new adjustment value is received). It will be appreciated that in the absence of a new start offset adjustment value the UE 3 may use an appropriate value (e.g. ‘0’, ‘1’, ‘2’ etc.) as the adjustment value unless the base station 5 indicates a specific adjustment value to the UE 3.

### Benefits

One of the benefits of this approach is that the DRX configuration is more adaptive and it may suit a wider range of services, such as XR data.

In a CU-DU split architecture, based on the base station's observation/prediction of packet arrival timing, the scheduler of the DU may be able to dynamically adjust the DRX cycle start offset (i.e. on duration position) using MAC/PHY signalling instead of RRC signalling. This would also result in shorter buffering times, shorter reconfiguration delays, better user experience, and improved power saving (at the UE).

It may also be useful when the system frame number (SFN) wraps around which may result in the actual gap between two consecutive on-durations (wake up windows) to be different to the DRX cycle length.

### Solution 2

In this case, the base station 5 (using its power saving/DRX control module 65) configures the UE 3 with a DRX cycle. The base station 5 may use RRC signalling and/or MAC signalling, as appropriate. The DRX cycle configuration may include information identifying multiple candidate on durations within the DRX cycle. Beneficially, each on duration may have a different starting-subframe. In other words, each candidate on duration may be considered as a single on duration plus a different offset.

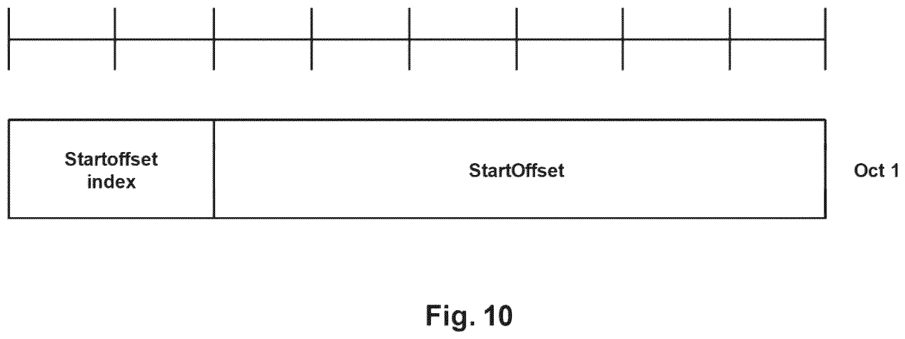

If RRC configuration is used, the starting point of each candidate on duration may be indicated using an associated start offset. The start offsets may be included in respective RRC information elements such as a ‘PrimaryStartOffset’, a ‘SecondaryStartOffset’, a ‘StartOffset #1’, a ‘StartOffset #2’, a ‘StartOffset #3’ information element and/or the like. Each information element may include an index associated with the given on duration and a corresponding start offset value. If MAC signalling is used, each on period may be assigned an appropriate index and a corresponding start offset value, as shown in FIG. 10. Thus, when the base station 5 needs to adjust the start point for the current iteration of the DRX cycle, it only needs to indicate (via MAC/PHY/DCI signalling) the index of the applicable on duration (start offset) to the UE 3.

Beneficially, the base station 5 and the UE 3 are able to dynamically adjust the on duration to the arrival time of a data packet, using the index of the on duration applicable for the current DRX cycle (or starting from the current DRX cycle).

When the UE 3 receives information (e.g. MAC CE) identifying the index of the start offset/on duration for a new iteration of the DRX cycle, the UE 3 has the following options:
If a start offset with the same index has been received before, the UE 3 may replace the existing value.
If a new index (new start offset) is received, the UE 3 is configured with a new on duration. Thus, in this case the UE 3 starts the associated on duration timer when following formula is true for any configured StartOffset, for a long DRX cycle:

$$[ ( SFN \times 10 ) + subframe number ] modulo ( drx - LongCycle ) = drx - StartOffset$$

and, for a short DRX cycle:

$$[ ( SFN \times 10 ) + subframe number ] modulo ( drx - ShortCycle ) = ( drx - StartOffset ) modulo ( drx - ShortCycle )$$

### Benefits

This approach makes it possible to dynamically adapt the UE's DRX configuration to suit a wide range of services, such as XR data. This approach may be particularly beneficial in case of the multiple streams model (e.g. two-eye model), where the streams have the same periodicity but packets/frames from the two streams arrive with a time offset (respective to each other). The approach may also be used to adapt the DRX configuration to reduce the effects of jitter, as the network may configure several similar (overlapping) on-durations. Upon data arrival and successful transmission, the UE 3 can automatically cancel any following on-durations (or the network may instruct the UE 3 to cancel them, e.g. using a DRX Command MAC CE).

### Solution 3

In this case, two or more DRX configurations may be provided to the UE 3 (e.g. via one or more RRC signalling messages). For example, the DRX configurations may be included in respective ‘DRX-Config’ information elements, and they may be identified by an associated index. Each DRX configuration may have its own DRX parameters defining an associated DRX cycle, independently from any other DRX cycle configured for that UE 3. Each DRX configuration may be applied to all serving cells or a subset of serving cells. Thus, each serving cell may be linked to one or more DRX configurations.

The base station 5 indicates to the UE 3 the DRX configuration to be used via MAC/PHY/DCI signalling. Accordingly, it is possible to adapt the DRX configuration dynamically by changing between different DRX configurations by indicating in the MAC/PHY/DCI signalling the index of the currently used DRX configuration. Similarly to the other solutions, this approach allows the base station 5 and the UE 3 to dynamically adjust the on duration to the arrival time of a data packet based on the index (since each DRX configuration can be configured with its own starting point). It will be appreciated that the indication of the DRX configuration index may be combined with the indication of an associated start offset (using a MAC CE as shown in FIG. 8) or the indication of a start offset adjustment (using the MAC CE as shown in FIG. 9, where ‘R’ represents the DRX configuration index).

This approach may be particularly useful for multiple streams cases (e.g. separate video and audio streams).

In an exemplary scenario, at least one serving cell may be linked to a first DRX configuration (DRX-config #1) which is suitable for audio stream (relatively shorter periodicity, smaller packets), and all serving cells (at least one other serving cell) may be linked to a second DRX configuration (DRX-config #2) which is suitable for video steam (relatively longer periodicity and bigger packets/frame).

For a serving cell linked to both DRX configurations, the UE 3 determines the active time to include the subframes in which at least one of the on duration timer (drx-onDurationTimer) and inactivity timer (drx-InactivityTimer) is running according to either DRX configuration, by taking into account the received/activated DRX configurations and any start offset value (per DRX configuration).

### Solution 4

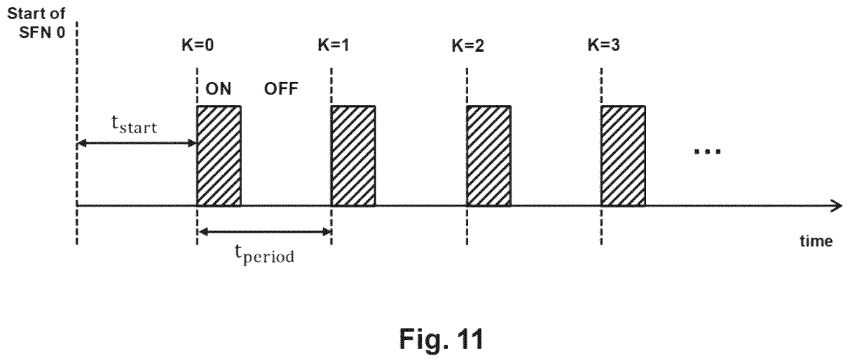

FIG. 11 illustrates schematically a discontinuous reception pattern that is defined by the following two parameters:
tₛₜₐᵣₜ: offset of the first on duration measured from the start of (a specific) SFN #0; and
t_{period}: period between the start points of two consecutive on durations.

Beneficially, these parameters allow the base station 5 and the UE 3 to use a discontinuous reception pattern that is not limited to the 1 ms (subframe level) granularity of the current DRX approach.

In principle the parameters tₛₜₐᵣₜ and t_{period} may have any arbitrary value but in practice it would be more convenient to define them as multiples of a basic unit, e.g. 1/1024 ms. For example, for a 60 fps period the value of t_{period} may be defined as:

$${t}_{period} = 17067 \times ( 1 / 1024 ) ms .$$

A subframe is the start of the k-th on duration if the following condition is met:

$$⌈ \frac{{t}_{start} + k \cdot {t}_{period}}{1 ms} ⌉ mod ( MAX\_SFN \times 10 ) = ( SFN \times 10 ) + subframe\_number$$

In practice, the UE 3 (and the base station 5) can determine the on duration by maintaining a counter for k between consecutive on durations to calculate the starting subframe of the next on duration.

It will be appreciated that the DRX pattern/cycle does not reset or change when the SFN wraps around to zero (otherwise the alignment with the data packets could be lost). Accordingly, tₛₜₐᵣₜ is defined with respect to a specific SFN=0 boundary (in the current system frame) rather than SFN=0 in every system frame. Alternatively, the initial tₛₜₐᵣₜ offset may be defined with respect to any other specific point or subframe. It will be appreciated that the parameters tₛₜₐᵣₜ and t_{period} may be signalled to the UE 3 and/or updated using any suitable control signalling (e.g. RRC/MAC/PHY/DCI). It will also be appreciated that the parameters t_{period} may be determined by the UE 3 implicitly for example based on the type of service being used (e.g. a 60 fps video stream may have an associated t_{period} value, and a 90 fps video stream may have a different associated t_{period} value). In this case only the parameter tₛₜₐᵣₜ needs to be signalled to the UE 3.

It will be appreciated that the length of the on periods is also provided to the UE3 (e.g. via RRC/MAC). The on periods may always start at t_{period} apart and each on period may be terminated upon receipt of an appropriate MAC CE (e.g. DRX Command MAC CE or Long DRX Command MAC CE). It will be appreciated that the start of each on period may be adjusted (e.g. to account for the effect of jitter) by providing an appropriate offset (a slot or a subframe level offset) in a similar manner as described in the previous solutions.

### Solution 5

A discontinuous reception pattern that is not limited to the 1 ms (subframe level) granularity may also be defined by reusing one of the above described modulo formulas to some extent. In this case the configuration granularity is provided at slot level for both the DRX cycle and the start offset to allow a more accurate matching between the DRX configuration and the traffic arrival times.

Specifically, the formula may be adapted to use at least one additional parameter (for example a ‘drx-LongCyclesub’ parameter or similar) for slot granularity of the DRX cycle configuration. This parameter may be defined in the DRX-config information element (see the full ASN.1 definition in the frame below).

In this example, the drx-LongCyclesub parameter defines a fraction of the long DRX cycle at slot level granularity (e.g. INTEGER (0 . . . 31), i.e. an integer number indicating a number of slots between 0 and 31). Note that this is different to the ‘SlotOffset’ parameter which defines a slot level delay before starting the on duration. It will be appreciated that a similar parameter may be defined for the short DRX cycle as well (e.g. a ‘drx-ShortCyclesub’ parameter or similar).

Beneficially, the UE 3 may use the following formula to determine when to start the on duration timer (in which specific slot). Specifically, the UE 3 starts the timer when following formula is true for the current SFN, subframe number, and slot number:

[(SFN×10)×number of slot per subframe+subframe number×number of slot per subframe+slot number]modulo(drx-LongCycle×number of slot per subframe+drx-LongCyclesub)=drx-StartOffset×number of slot per subframe+drx-SlotOffset

Whilst the above formula uses the parameter drx-SlotOffset, it will be appreciated that a different parameter may be used to configure an appropriate slot level start offset. It will also be appreciated that at least one of the slot granularity of the DRX cycle (e.g. ‘drx-LongCyclesub’) and the slot level offset (e.g. ‘drx-SlotOffset’) may also be indicated or updated via MAC/PHY/DCI, similarly to the subframe level offset in the above described solutions.

- DRX-Config
This IE DRX-Config is used to configure DRX related parameters.
DRX-Config information element
-- ASN1START
-- TAG-DRX-CONFIG-START

| | |
|---|---|
| DRX-Config ::= | SEQUENCE { |
| drx-onDurationTimer | CHOICE { |
| subMilliSeconds | INTEGER (1..31), |
| milliSeconds | ENUMERATED { |

```
        ms1, ms2, ms3, ms4, ms5, ms6, ms8, ms10, ms20, ms30, ms40, ms50,
          ms60, ms80, ms100, ms200, ms300, ms400, ms500, ms600, ms800,
          ms1000, ms1200, s1600, spare8, spare7, spare6, spare5,
          spare4, spare3, spare2, spare1 }
```

| | |
|---|---|
| | }, |
| drx-InactivityTimer | ENUMERATED { |

```
        ms0, ms1, ms2, ms3, ms4, ms5, ms6, ms8, ms10, ms20, ms30, ms40,
          ms50, ms60, ms80, ms100, ms200, ms300, ms500, ms750, ms1280,
          ms1920, ms2560, spare9, spare8, spare7, spare6, spare5,
          spare4, spare3, spare2, spare1},
```

| | |
|---|---|
| drx-HARQ-RTT-TimerDL | INTEGER (0..56), |
| drx-HARQ-RTT-TimerUL | INTEGER (0..56), |
| drx-RetransmissionTimerDL | ENUMERATED { |

```
        sl0, sl1, sl2, sl4, sl6, sl8, sl16, sl24, sl33, sl40, sl64,
          sl80, sl96, sl112, sl128, sl160, sl320, spare15, spare14,
          spare13, spare12, spare11, spare10, spare9, spare8, spare7,
          spare6, spare5, spare4, spare3, spare2, spare1},
```

| | |
|---|---|
| drx-RetransmissionTimerUL | ENUMERATED { |

```
        sl0, sl1, sl2, sl4, sl6, sl8, sl16, sl24, sl33, sl40, sl64,
          sl80, sl96, sl112, sl128, sl160, sl320, spare15, spare14,
          spare13, spare12, spare11, spare10, spare9, spare8, spare7,
          spare6, spare5, spare4, spare3, spare2, spare1 },
```

| | |
|---|---|
| drx-LongCycleStartOffset | CHOICE { |
| ms10 | INTEGER(0..9), |
| ms20 | INTEGER(0..19), |
| ms32 | INTEGER(0..31), |
| ms40 | INTEGER(0..39), |
| ms60 | INTEGER(0..59), |
| ms64 | INTEGER(0..63), |
| ms70 | INTEGER(0..69), |
| ms80 | INTEGER(0..79), |
| ms128 | INTEGER(0..127), |
| ms160 | INTEGER(0..159), |
| ms256 | INTEGER(0..255), |
| ms320 | INTEGER(0..319), |
| ms512 | INTEGER(0..511), |
| ms640 | INTEGER(0..639), |
| ms1024 | INTEGER(0..1023), |
| ms1280 | INTEGER(0..1279), |
| ms2048 | INTEGER(0..2047), |
| ms2560 | INTEGER(0..2559), |
| ms5120 | INTEGER(0..5119), |
| ms10240 | INTEGER(0..10239) |

},

| | |
|---|---|
| shortDRX | SEQUENCE { |
| drx-ShortCycle | ENUMERATED { |
| | ms2, ms3, ms4, ms5, ms6, ms7, ms8, ms10, ms14, ms16, |
| | ms20, ms30, ms32, ms35, ms40, ms64, ms80, ms128, |
| | ms160, ms256, ms320, ms512, ms640, spare9, spare8, |
| | spare7, spare6, spare5, spare4, spare3, spare2, |
| | spare1 }, |
| drx-ShortCycleTimer | INTEGER (1..16) |
| } | OPTIONAL, -- Need R |
| drx-SlotOffset | INTEGER (0..31) |

}
-- TAG-DRX-CONFIG-STOP
-- ASN1STOP

### Modifications and Alternatives

Detailed embodiments have been described above. As those skilled in the art will appreciate, a number of modifications and alternatives can be made to the above embodiments whilst still benefiting from the disclosures embodied therein. By way of illustration only a number of these alternatives and modifications will now be described.

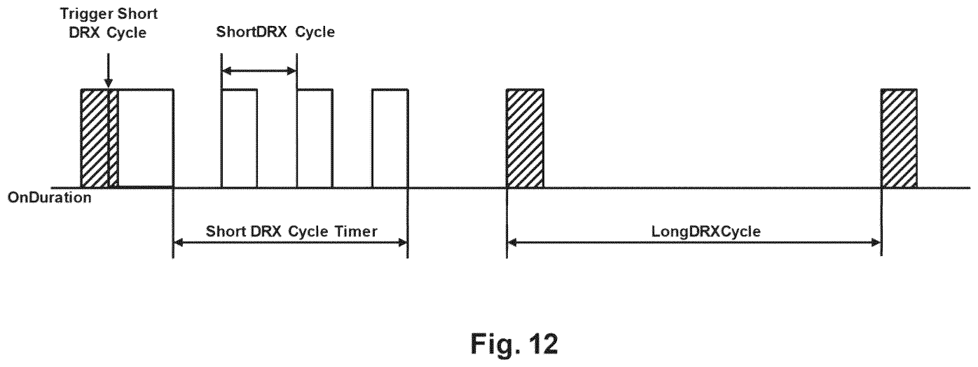

FIG. 12 illustrates schematically the relationship between a long DRX cycle and a short DRX cycle. It will be appreciated that the above description is applicable to both the long DRX cycle and the short DRX cycle. It will also be appreciated that a long or short DRX cycle may be used in combination with solution 4 or 5, if appropriate. In other words, a discontinuous reception pattern that is not limited to the subframe level (1 ms) granularity may be configured in addition to, or instead of, a long or a short DRX cycle.

It will be appreciated that a first start offset value (whether provided via RRC or MAC CE) may specify a starting point on a subframe level, and a subsequent start offset value or start offset adjustment value may be used for a more granular (slot or symbol level) indication of the starting point. Alternatively, a first octet of a MAC CE may specify a starting point on a subframe level, and a second octet may specify a starting point on a slot or symbol level. In case of RRC signalling appropriate information elements may be used to specify the starting point on a subframe level, slot level, and/or symbol level. Each one of the subframe, slot, and symbol of the starting point may be indicated using an associated index. The MAC CE or RRC information element may also specify a point in time instead of a subframe index (in a system frame), a slot index (in a subframe), and/or symbol (within a slot).

It will be appreciated that, in a modification of solution 5, symbol level granularity for the cycle and active time may be realised using an appropriate formula which takes into account an additional parameter that specifies the applicable further symbol level DRX length. For example, this symbol level parameter may define additional DRX cycle portion at symbol granularity in addition to a DRX cycle portion configured in number of subframes and in number of slots. Beneficially, for each iteration of the cycle, the UE can determine a SFN, subframe number, slot number, and symbol number for starting the on duration timer, using the formula. The parameter that specifies the applicable further symbol level DRX length may be configured via the DRX-config information element described above.

It will be appreciated that the above embodiments may be applied to both 5G New Radio and LTE systems (E-UTRAN). The above embodiments may also be applied to future systems (beyond 5G, 6G, etc.).

In the above description, the UE, the access network node (base station), and the core network node are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above embodiments, a number of software modules were described. As those skilled in the art will appreciate, the software modules may be provided in compiled or un-compiled form and may be supplied to the UE, the access network node (base station), and the core network node as a signal over a computer network, or on a recording medium. Further, the functionality performed by part or all of this software may be performed using one or more dedicated hardware circuits. However, the use of software modules is preferred as it facilitates the updating of the UE, the access network node, and the core network node in order to update their functionalities.

It will be appreciated that the functionality of a base station (referred to as a ‘distributed’ base station or gNB) may be split between one or more distributed units (DUs) and a central unit (CU) with a CU typically performing higher level functions and communication with the next generation core and with the DU performing lower level functions and communication over an air interface with UEs in the vicinity (i.e. in a cell operated by the gNB). A distributed gNB includes the following functional units:
gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the so-called F1 interface connected with the gNB-DU.
gNB Distributed Unit (gNB-DU): a logical node hosting Radio Link Control (RLC), Medium Access Control (MAC) and Physical (PHY) layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.
gNB-CU-Control Plane (gNB-CU-CP): a logical node hosting the RRC and the control plane part of the PDCP protocol of the gNB-CU for an en-gNB or a gNB. The gNB-CU-CP terminates the so-called E1 interface connected with the gNB-CU-UP and the F1-C (F1 control plane) interface connected with the gNB-DU.
gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

It will be appreciated that when a distributed base station or a similar control plane-user plane (CP-UP) split is employed, the base station may be split into separate control-plane and user-plane entities, each of which may include an associated transceiver circuit, antenna, network interface, controller, memory, operating system, and communications control module. When the base station comprises a distributed base station, the network interface (reference numeral 55 in FIG. 3) also includes an E1 interface and an F1 interface (F1-C for the control plane and F1-U for the user plane) to communicate signals between respective functions of the distributed base station. In this case, the communications control module is also responsible for communications (generating, sending, and receiving signalling messages) between the control-plane and user-plane parts of the base station. It will be appreciated that when a distributed base station is used there is no need to involve both the control-plane and user-plane parts for pre-emption of communication resources as described in the above exemplary embodiments. It will be appreciated that pre-emption may be handled by the user-plane part of the base station without involving the control-plane part (or vice versa).

The above embodiments are also applicable to ‘non-mobile’ or generally stationary user equipment. The above described mobile device may comprise an MTC/IoT device and/or the like.

The User Equipment (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to ‘internet of things’ (IoT), using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table (source: 3GPP TS 22.368 V13.1.0, Annex B, the contents of which are incorporated herein by reference). This list is not exhaustive and is intended to be indicative of some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an Mobile Virtual Network Operator (MVNO) service, an emergency radio communication system, a Private Branch eXchange (PBX) system, a PHS/Digital Cordless Telecommunications system, a Point of sale (POS) system, an advertise calling system, a Multimedia Broadcast and Multicast Service (MBMS), a Vehicle to Everything (V2X) system, a train radio system, a location related service, a Disaster/Emergency Wireless Communication Service, a community service, a video streaming service, a femto cell application service, a Voice over LTE (VoLTE) service, a charging service, a radio on demand service, a roaming service, an activity monitoring service, a telecom carrier/communication NW selection service, a functional restriction service, a Proof of Concept (PoC) service, a personal information management service, an ad-hoc network/Delay Tolerant Networking (DTN) service, etc.

Further, the above-described UE categories are merely examples of applications of the technical ideas and exemplary embodiments described in the present document. Needless to say, these technical ideas and embodiments are not limited to the above-described UE and various modifications can be made thereto.

The second information may include at least one of: information identifying a start offset relative to a starting point of the current iteration of the cycle; information identifying an adjustment value to be applied to a current start offset; information identifying an index of a specific starting subframe; information identifying a discontinuous reception configuration to be applied in the current iteration of the cycle; information identifying a length of the active portion in the current iteration of the cycle; and information indicating whether the active portion is enabled in the current iteration of the cycle.

The method performed by the UE may further comprise applying the first information for the discontinuous reception upon receiving the second information for a first iteration of the cycle.

The method performed by the UE may further comprise determining, prior to receiving the second information, an initial starting subframe of the active portion based on the first information.

The first information may configure a plurality of candidate active portions for the cycle, each candidate active portion having an associated starting point; and the second information may identify, for the current iteration of the cycle, the starting subframe by indicating which candidate active portion is to be used by the UE.

Each candidate active portion may be configured based on a respective offset to be applied to a common starting point.

The first information may include respective configurations for a plurality of cycles, each cycle having an associated active portion and an associated inactive portion; and the second information may identify which configuration of the plurality of configurations is to be used by the UE. In this case, the method performed by the UE may include receiving data in the associated active portion of the configuration identified by the second information.

The first information may include a respective index for each configuration and the second information may identify the configuration to be used based on its index.

At least one of the first control signalling and the second signalling may include radio resource control (RRC) signalling. The second control signalling may include at least one of: RRC signalling, medium access control (MAC) signalling; a MAC control element; physical layer (PHY) signalling; and a downlink control information (DCI).

The receiving the second information may include receiving the second information in an information element or a control element.

The second information may identify each one of the at least one active portion based on an index associated with that active portion.

The starting point may be a point in time or a point defined with a subframe/slot/symbol granularity.

The method performed by the UE may further comprise determining, for the current iteration of the cycle, the starting point of the active portion using a formula based on the second information.

The first information may configure the UE for discontinuous reception of two data streams based on two associated cycles; and the method performed by the UE may further comprise receiving third information that identifies, for a current iteration of at least one of the two cycles, a starting point of the active portion for reception of the associated data stream.

The cycle may be defined based on at least one of a number of slots, a number of symbols, and a time value related to the arrival rate of the data packets. The time value may be given in units of 1/(2n) ms, where ‘n’ is an integer number.

The method performed by the UE may further comprise determining at least one of a starting subframe, a starting slot, and a starting symbol for an active portion of a current iteration of the cycle using at least one formula based on the information identifying the offset and the periodicity.

The method performed by the UE may further comprise receiving at least one of the information identifying the length of the cycle and the length of the active portion using an RRC message.

The method performed by the UE may further comprise determining at least one of a starting slot and a starting symbol for a current iteration of the cycle using at least one formula based on the information identifying the length of the cycle and the length of the active portion.

The data transmitted to the UE in the active portion(s) may comprise user data (e.g. data packets for a specific service) and/or control data such as PDCCH signalling, RRC signalling, or similar.

Various other modifications will be apparent to those skilled in the art and will not be described in further detail here.

For example, the whole or part of the exemplary embodiments disclosed above can be described as, but not limited to, the following supplementary notes.

### (Supplementary Note 1)

A method performed by a user equipment (UE), the method comprising:
receiving, via a first control signalling, first information for configuring the UE with a discontinuous reception of data based on a cycle, wherein the cycle includes an active portion during which data may be transmitted for the UE and an inactive portion during which data is not transmitted for the UE;
receiving, via a second control signalling, second information for identifying, for a current iteration of the cycle, a starting point of the active portion; and
receiving data in the active portion of the current iteration of the cycle, based on the starting point identified by the second information.

### (Supplementary Note 2)

The method according to supplementary note 1, wherein the second information includes at least one of: information identifying a start offset relative to a starting point of the current iteration of the cycle; information identifying an adjustment value to be applied to a current start offset; information identifying an index of a specific starting subframe; information identifying a discontinuous reception configuration to be applied in the current iteration of the cycle;
information identifying a length of the active portion in the current iteration of the cycle; and information indicating whether the active portion is enabled in the current iteration of the cycle.

### (Supplementary Note 3)

The method according to supplementary note 1 or 2, further comprising applying the first information for the discontinuous reception upon receiving the second information for a first iteration of the cycle.

### (Supplementary Note 4)

The method according to supplementary note 1 or 2, further comprising determining, prior to receiving the second information, an initial starting subframe of the active portion based on the first information.

### (Supplementary Note 5)

The method according to any of supplementary notes 1 to 4, wherein
the first information configures a plurality of candidate active portions for the cycle, each candidate active portion having an associated starting point; and
the second information identifies, for the current iteration of the cycle, the starting subframe by indicating which candidate active portion is to be used by the UE.

### (Supplementary Note 6)

The method according to supplementary note 5, wherein each candidate active portion is configured based on a respective offset to be applied to a common starting point.

### (Supplementary Note 7)

The method according to any of supplementary notes 1 to 6, wherein
the first information includes respective configurations for a plurality of cycles, each cycle having an associated active portion and an associated inactive portion; and
the second information identifies which configuration of the plurality of configurations is to be used by the UE; and
the method includes receiving data in the associated active portion of the configuration identified by the second information.

### (Supplementary Note 8)

The method according to supplementary note 7, wherein the first information includes a respective index for each configuration and the second information identifies the configuration to be used based on its index.

### (Supplementary Note 9)

The method according to any of supplementary notes 1 to 8, wherein at least one of the first control signalling and the second signalling includes radio resource control (RRC) signalling.

### (Supplementary Note 10)

The method according to any of supplementary notes 1 to 9, wherein the second control signalling includes at least one of: medium access control (MAC) signalling; a MAC control element; physical layer (PHY) signalling; and a downlink control information (DCI).

### (Supplementary Note 11)

A method performed by a user equipment (UE), the method comprising:
receiving first information for configuring the UE for discontinuous reception of data based on a cycle, wherein the cycle includes a plurality of active portions during which data may be transmitted for the UE and at least one inactive portion during which data is not transmitted for the UE;
receiving second information identifying, for at least one active portion, a respective offset for a starting point of that active portion in a current iteration of the cycle; and
receiving data in the plurality of active portions in the current iteration of the cycle, based on the second information.

### (Supplementary Note 12)

The method according to supplementary note 11, wherein the receiving the second information includes receiving the second information in an information element or a control element.

### (Supplementary Note 13)

The method according to supplementary note 11 or 12, wherein the second information identifies each one of the at least one active portion based on an index associated with that active portion.

### (Supplementary Note 14)

The method according to any of supplementary notes 1 to 13, wherein the starting point is a point in time or a point defined with a subframe/slot/symbol granularity.

### (Supplementary Note 15)

The method according to any of supplementary notes 1 to 14, further comprising determining, for the current iteration of the cycle, the starting point of the active portion using a formula based on the second information.

### (Supplementary Note 16)

A method performed by a user equipment (UE), the method comprising:
receiving first information for configuring the UE for discontinuous reception of data based on a plurality of cycles, wherein each cycle includes an active portion during which data may be transmitted for the UE and an inactive portion during which data is not transmitted for the UE;
receiving second information identifying at least one cycle to be used by the UE in at least one cell; and
receiving data in the active portion in a current iteration of the at least one cycle.

### (Supplementary Note 17)

The method according to supplementary note 16,
wherein the first information configures the UE for discontinuous reception of two data streams based on two associated cycles; and
the method further comprises receiving third information that identifies, for a current iteration of at least one of the two cycles, a starting point of the active portion for reception of the associated data stream.

### (Supplementary Note 18)

A method performed by a user equipment (UE), the method comprising:
receiving information for configuring the UE for a discontinuous reception of data based on a cycle defined as a function of an arrival rate of data packets for a service, wherein the cycle includes an active portion during which data may be transmitted for the UE and an inactive portion during which data is not transmitted for the UE,
wherein the information includes information identifying an offset for determining a starting time of an initial active portion in relation to a specific system frame and information identifying a periodicity between the starting time of the initial active portion and a starting time of any subsequent active portion.

### (Supplementary Note 19)

The method according to supplementary note 18, wherein the cycle is defined based on at least one of a number of slots, a number of symbols, and a time value related to the arrival rate of the data packets.

### (Supplementary Note 20)

The method according to supplementary note 19, wherein the time value is given in units of 1/(2n) ms, where ‘n’ is an integer number.

### (Supplementary Note 21)

The method according to any of supplementary notes 18 to 20, further comprising determining at least one of a starting subframe, a starting slot, and a starting symbol for an active portion of a current iteration of the cycle using at least one formula based on the information identifying the offset and the periodicity.

### (Supplementary Note 22)

A method performed by a user equipment (UE), the method comprising:
receiving information for configuring the UE with a discontinuous reception of data based on a cycle, wherein the cycle includes an active portion during which data may be transmitted for the UE and an inactive portion during which data is not transmitted for the UE,
wherein the information includes information identifying, on a slot or a symbol level, a length of the cycle and a length of the active portion.

### (Supplementary Note 23)

The method according to supplementary note 22, further comprising receiving at least one of the information identifying the length of the cycle and the length of the active portion using an RRC message.

### (Supplementary Note 24)

The method according to supplementary note 22 or 23, further comprising determining at least one of a starting slot and a starting symbol for a current iteration of the cycle using at least one formula based on the information identifying the length of the cycle and the length of the active portion.

### (Supplementary Note 25)

A method performed by base station, the method comprising:
transmitting, to a user equipment (UE), via a first control signalling, first information for configuring the UE with a discontinuous reception of data based on a cycle, wherein the cycle includes an active portion during which data may be transmitted for the UE and an inactive portion during which data is not transmitted for the UE;
transmitting, to the UE, via a second control signalling, second information for identifying, for a current iteration of the cycle, a starting point of the active portion; and
transmitting, to the UE, data in the active portion of the current iteration of the cycle, based on the starting point identified by the second information.

### (Supplementary Note 26)

A method performed by base station, the method comprising:
transmitting, to a user equipment (UE), first information for configuring the UE for discontinuous reception of data based on a cycle, wherein the cycle includes a plurality of active portions during which data may be transmitted for the UE and at least one inactive portion during which data is not transmitted for the UE;
transmitting, to the UE, second information identifying, for at least one active portion, a respective offset for a starting point of that active portion in a current iteration of the cycle; and
transmitting, to the UE, data in the plurality of active portions in the current iteration of the cycle, based on the second information.

### (Supplementary Note 27)

A method performed by base station, the method comprising:
transmitting, to a user equipment (UE), first information for configuring the UE for discontinuous reception of data based on a plurality of cycles, wherein
each cycle includes an active portion during which data may be transmitted for the UE and an inactive portion during which data is not transmitted for the UE;
transmitting, to the UE, second information identifying at least one cycle to be used by the UE in at least one cell; and
transmitting, to the UE, data in the active portion in a current iteration of the at least one cycle.

### (Supplementary Note 28)

A method performed by base station, the method comprising:
transmitting, to a user equipment (UE), information for configuring the UE for a discontinuous reception of data based on a cycle defined as a function of an arrival rate of data packets for a service, wherein the cycle includes an active portion during which data may be transmitted for the UE and an inactive portion during which data is not transmitted for the UE,
wherein the information includes information identifying an offset for determining a starting time of an initial active portion in relation to a specific system frame and information identifying a periodicity between the starting time of the initial active portion and a starting time of any subsequent active portion.

### (Supplementary Note 29)

A method performed by base station, the method comprising:
transmitting, to a user equipment (UE), information for configuring the UE with a discontinuous reception of data based on a cycle, wherein the cycle includes an active portion during which data may be transmitted for the UE and an inactive portion during which data is not transmitted for the UE,
wherein the information includes information identifying, on a slot or a symbol level, a length of the cycle and a length of the active portion.

### (Supplementary Note 30)

A user equipment (UE) comprising:
means for receiving, via a first control signalling, first information for configuring the UE with a discontinuous reception of data based on a cycle, wherein the cycle includes an active portion during which data may be transmitted for the UE and an inactive portion during which data is not transmitted for the UE;
means for receiving, via a second control signalling, second information for identifying, for a current iteration of the cycle, a starting point of the active portion; and
means for receiving data in the active portion of the current iteration of the cycle, based on the starting point identified by the second information.

### (Supplementary Note 31)

A user equipment (UE) comprising:
means for receiving first information for configuring the UE for discontinuous reception of data based on a cycle, wherein the cycle includes a plurality of active portions during which data may be transmitted for the UE and at least one inactive portion during which data is not transmitted for the UE;
means for receiving second information identifying, for at least one active portion, a respective offset for a starting point of that active portion in a current iteration of the cycle; and
means for receiving data in the plurality of active portions in the current iteration of the cycle, based on the second information.

### (Supplementary Note 32)

A user equipment (UE) comprising:
means for receiving first information for configuring the UE for discontinuous reception of data based on a plurality of cycles, wherein each cycle includes an active portion during which data may be transmitted for the UE and an inactive portion during which data is not transmitted for the UE;
means for receiving second information identifying at least one cycle to be used by the UE in at least one cell; and
means for receiving data in the active portion in a current iteration of the at least one cycle.

### (Supplementary Note 33)

A user equipment (UE) comprising:
means for receiving information for configuring the UE for a discontinuous reception of data based on a cycle defined as a function of an arrival rate of data packets for a service, wherein the cycle includes an active portion during which data may be transmitted for the UE and an inactive portion during which data is not transmitted for the UE,
wherein the information includes information identifying an offset for determining a starting time of an initial active portion in relation to a specific system frame and information identifying a periodicity between the starting time of the initial active portion and a starting time of any subsequent active portion.

### (Supplementary Note 34)

A user equipment (UE) comprising:
means for receiving information for configuring the UE with a discontinuous reception of data based on a cycle, wherein the cycle includes an active portion during which data may be transmitted for the UE and an inactive portion during which data is not transmitted for the UE,
wherein the information includes information identifying, on a slot or a symbol level, a length of the cycle and a length of the active portion.

### (Supplementary Note 35)

A base station comprising:
means for transmitting, to a user equipment (UE), via a first control signalling, first information for configuring the UE with a discontinuous reception of data based on a cycle, wherein the cycle includes an active portion during which data may be transmitted for the UE and an inactive portion during which data is not transmitted for the UE;
means for transmitting, to the UE, via a second control signalling, second information for identifying, for a current iteration of the cycle, a starting point of the active portion; and
means for transmitting, to the UE, data in the active portion of the current iteration of the cycle, based on the starting point identified by the second information.

### (Supplementary Note 36)

A base station comprising:
means for transmitting, to a user equipment (UE), first information for configuring the UE for discontinuous reception of data based on a cycle, wherein
the cycle includes a plurality of active portions during which data may be transmitted for the UE and at least one inactive portion during which data is not transmitted for the UE;
means for transmitting, to the UE, second information identifying, for at least one active portion, a respective offset for a starting point of that active portion in a current iteration of the cycle; and
means for transmitting, to the UE, data in the plurality of active portions in the current iteration of the cycle, based on the second information.

### (Supplementary Note 37)

A base station comprising:
means for transmitting, to a user equipment (UE), first information for configuring the UE for discontinuous reception of data based on a plurality of cycles, wherein each cycle includes an active portion during which data may be transmitted for the UE and an inactive portion during which data is not transmitted for the UE;
means for transmitting, to the UE, second information identifying at least one cycle to be used by the UE in at least one cell; and
means for transmitting, to the UE, data in the active portion in a current iteration of the at least one cycle.

### (Supplementary Note 38)

A base station comprising:
means for transmitting, to a user equipment (UE), information for configuring the UE for a discontinuous reception of data based on a cycle defined as a function of an arrival rate of data packets for a service, wherein the cycle includes an active portion during which data may be transmitted for the UE and an inactive portion during which data is not transmitted for the UE,
wherein the information includes information identifying an offset for determining a starting time of an initial active portion in relation to a specific system frame and information identifying a periodicity between the starting time of the initial active portion and a starting time of any subsequent active portion.

### (Supplementary Note 39)

A base station comprising:
means for transmitting, to a user equipment (UE), information for configuring the UE with a discontinuous reception of data based on a cycle,
wherein the cycle includes an active portion during which data may be transmitted for the UE and an inactive portion during which data is not transmitted for the UE,
wherein the information includes information identifying, on a slot or a symbol level, a length of the cycle and a length of the active portion.

This application is based upon and claims the benefit of priority from Great Britain Patent Application No. 2205219.5, filed on Apr. 8, 2022, the disclosure of which is incorporated herein in its entirety by reference.

### REFERENCE SIGNS LIST

1 TELECOMMUNICATION SYSTEM
3 MOBILE DEVICE
5 BASE STATION
7 CORE NETWORK
10 CONTROL PLANE FUNCTION (CPF)
11 USER PLANE FUNCTION (UPF)
20 DATA NETWORK
31 TRANSCEIVER CIRCUIT
33 ANTENNA
35 USER INTERFACE
37 CONTROLLER
39 MEMORY
41 OPERATING SYSTEM
43 COMMUNICATIONS CONTROL MODULE
45 POWER SAVING MODULE
51 TRANSCEIVER CIRCUIT
53 ANTENNA
55 NETWORK INTERFACE
57 CONTROLLER
59 MEMORY
61 OPERATING SYSTEM
63 COMMUNICATIONS CONTROL MODULE
65 POWER SAVING/DRX CONTROL MODULE
71 TRANSCEIVER CIRCUIT
75 NETWORK INTERFACE
77 CONTROLLER
79 MEMORY
81 OPERATING SYSTEM
83 COMMUNICATIONS CONTROL MODULE

What is claimed is:

1-19. (canceled)

20. A method performed by a user equipment (UE), the method comprising:
receiving, from an access network node, information for indicating a start offset of an on-duration period of a discontinuous reception (DRX) cycle relative to a specific system frame number (SFN), and non-integer number of milliseconds of the on-duration period of the DRX cycle, the non-integer number of milliseconds corresponding to a video frame rate; and
configuring the on-duration period of the DRX cycle based on the information.

21. The method according to claim 20, wherein
the specific SFN is at least one of 0 or a predetermined number.

22. The method according to claim 20, wherein
the information includes information indicating the specific SFN.

23. The method according to claim 20, wherein
the information indicates a respective starting point of the on-duration period of a plurality of DRX cycles, and a respective non-integer number of milliseconds of the on-duration period of the plurality of the DRX cycles, and
each of the plurality of the DRX cycles corresponds to a respective data stream.

24. The method according to claim 20, further comprising:
receiving further information for adjusting at least one of the start offset or the on-duration period; and
adjusting the at least one of the start offset or the on-duration period based on the further information.

25. The method according to claim 24, wherein
the adjusting is performed by adjusting an on-duration period of a current iteration of the DRX cycle.

26. The method according to claim 24, wherein
the adjusting is performed by adjusting each on-duration period of following iterations of the DRX cycle.

27. The method according to claim 24, wherein
the adjusting is performed in a unit smaller than a subframe.

28. The method according to claim 24, wherein
the further information is transmitted by at least one of:
downlink control information (DCI);
a physical layer signaling;
a medium access control (MAC) control element (CE); or
a MAC signaling.

29. The method according to claim 20, wherein
the information is transmitted by a Radio Resource Control (RRC) message.

30. A method performed by an access network node, the method comprising:
transmitting, to a user equipment (UE), information for indicating a start offset of an on-duration period of a discontinuous reception (DRX) cycle relative to a specific system frame number (SFN), and non-integer number of milliseconds of the on-duration period of the DRX cycle, the non-integer number of milliseconds corresponding to a video frame rate, for configuring the UE with the on-duration period of the DRX cycle.

31. A user equipment (UE) comprising:
at least one memory storing instructions; and
at least one processor configured to process the instructions to:
receive, from an access network node, information for indicating a start offset of an on-duration period of a discontinuous reception (DRX) cycle relative to a specific system frame number (SFN), and non-integer number of milliseconds of the on-duration period of the DRX cycle, the non-integer number of milliseconds corresponding to a video frame rate; and
configure the on-duration period of the DRX cycle based on the information.

32. An access network node comprising:
at least one memory storing instructions; and
at least one processor configured to process the instructions to:
transmit, to a user equipment (UE), information for indicating a start offset of an on-duration period of a discontinuous reception (DRX) cycle relative to a specific system frame number (SFN), and non-integer number of milliseconds of the on-duration period of the DRX cycle, the non-integer number of milliseconds corresponding to a video frame rate, for configuring the UE with the on-duration period of the DRX cycle.
